(19) United States
(12) Patent Application Publication
(10) Pub. No.: US 2016/0115775 A1
(43) Pub. Date: Apr. 28, 2016

(54) Entraining Hydrate Particles in a Gas Stream

(71) Applicants: Michael W. EATON, Denver, CO (US); Douglas J. Turner, Kingwood, TX (US)

(72) Inventors: Michael W. EATON, Denver, CO (US); Douglas J. Turner, Kingwood, TX (US)

(21) Appl. No.: 14/845,431

(22) Filed: Sep. 4, 2015

Related U.S. Application Data
(60) Provisional application No. 62/067,286, filed on Oct. 22, 2014.

(51) Int. Cl. E21B 43/36; C10L 3/10; B01D 51/10

(52) U.S. Cl. CPC E21B 43/36; B01D 51/10; C10L 3/107; C10L 3/106; C10L 2290/06

(57) ABSTRACT

A method for entraining hydrate particles in a gas stream, including separating a raw gas stream into a bulk water stream and a partially dehydrated gas stream, chilling the partially dehydrated gas stream to form a chilled gas stream, combining the bulk water stream with the chilled gas stream to form a transport stream including the entrained hydrate particles, and flowing the transport stream to a facility.

### CROSS REFERENCE TO RELATED APPLICATIONS

This application claims the priority benefit of U.S. Patent Application 62/067,286 filed Oct. 22, 2014 entitled ENTRAINING HYDRATE PARTICLES IN A GAS STREAM, the entirety of which is incorporated by reference herein.

### FIELD

The present techniques relate to the carrying hydrate particles in a gas stream. Specifically, techniques are disclosed for forming and entraining hydrate particles in the gas stream.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

The presence of water in production fluids may cause problems while transporting a hydrocarbon due to the formation of clathrate hydrates with the hydrocarbons. Clathrate hydrates (commonly called hydrates) are weak composites formed from a water matrix and a guest molecule, such as methane or carbon dioxide, among others (collectively referred to herein as a “water matrix”). Hydrates may form, for example, at the high pressures and low temperatures that may be found in pipelines and other hydrocarbon equipment. After forming, the hydrates can agglomerate, leading to plugging or fouling of the equipment. Various techniques have been used to lower the ability for hydrates to form or cause plugging or fouling. Exemplary, but non-limiting techniques include insulation of lines, dehydration of the hydrocarbon, and the adding of thermodynamic hydrate inhibitors (THIs), kinetic hydrate inhibitors (KHIs), and/or anti-agglomerates (AAs).

Thermodynamic hydrate inhibitors, such as methanol, monoethylene glycol, diethylene glycol, triethylene glycol, and potassium formate, among others, lower the hydrate formation temperature, which may inhibit the formation of the hydrate under the conditions found in a particular process. Thermodynamic inhibitors can be very effective at hydrate prevention, but the quantities required for total inhibition are large and proportional to the amount of water produced, leading to increasing and even prohibitive quantities late in field life. See Valberg, T., “Efficiency of Thermodynamic Inhibitors for Melting Gas Hydrates,” Master's Thesis, Norwegian University of Science and Technology, Trondheim, Norway (2006). Low dosage hydrate inhibitors (LDHIs) exist, including kinetic hydrate inhibitors (KHIs) and anti-agglomeration agents (AAs).

Like THIs, KHIs prevent the formation of hydrates, but not by changing the thermodynamic conditions. Instead, KHIs inhibit the nucleation and growth of the hydrate crystals. Such materials may include, for example, Poly(2-alkyl-2-oxazoline) polymers (or poly(N-acylalkylene imine) polymers), poly(-alkyl-2-oxazoline) copolymers, and others. See Urdahl, Olav, et al., “Experimental testing and evaluation of a kinetic gas hydrate inhibitor in different fluid systems,” Preprints from the Spring 1997 Meeting of the ACS Division of Fuel Chemistry, 42, 498-502 (American Chemical Society, 1997).

For example, U.S. Pat. No. 6,359,047 discloses a gas hydrate inhibitor. The inhibitor includes, by weight, a copolymer including about 80 to about 95% of polyvinyl caprolactam (VCL) and about 5 to about 20% of N,N-dialkylaminoethyl(meth)acrylate or N-(3-dimethylaminopropyl) methacrylamide. As another example, U.S. Pat. No. 5,874,660 discloses a method for inhibiting hydrate formation. The method is used in treating a petroleum fluid stream, such as natural gas conveyed in a pipe, to inhibit the formation of a hydrate restriction in the pipe. The hydrate inhibitor used for practicing the method is selected from the family of substantially water soluble copolymers formed from N-methyl-N-vinylacetamide (VIMA) and one of three comonomers, vinylpyrrolidone (VP), vinylpiperidone (VPip), or vinylcaprolactam (VCap). VIMA/VCap is the preferred copolymer. These copolymers may be used alone or in combination with each other or other hydrate inhibitors. Preferably, a solvent, such as water, brine, alcohol, or mixtures thereof, is used to produce an inhibitor solution or mixture to facilitate treatment of the petroleum fluid stream.

Another type of low dosage hydrate inhibitor (LDHI) uses surface active agents (surfactants) that may function both as KHIs and as AAs. AAs may prevent the agglomeration, or self-sticking, of small hydrate crystals into larger hydrate crystals or groups of crystals. For example, U.S. Pat. Nos. 5,841,010 and 6,015,929 disclose the use of surface active agents as gas hydrate inhibitors for inhibiting the formation (nucleation, growth, and agglomeration) of clathrate hydrates. The methods comprise adding into a mixture comprising hydrate forming substituents and water, an effective amount of a hydrate inhibitor selected from the group consisting of anionic, cationic, non-ionic, and zwitterionic hydrate inhibitors. The hydrate inhibitor has a polar head group and a nonpolar tail group not exceeding 12 carbon atoms in the longest carbon chain. The AAs may allow for the formation of a flowable slurry, i.e., hydrates that can be carried by a flowing hydrocarbon without sticking to each other.

Related information may be found in U.S. Pat, Nos. 6,957,146; 5,936,040; 5,841,010; and 5,744,665. Further information may be found in: U.S. Patent Application Publication Nos. 2004/0133531, 2006/0092766, 2008/0312478 and 2007/0129256; Sloan, E. D., “Gas Hydrate Tutorial,” Preprints from the Spring 1997 Meeting of the ACS Division of Fuel Chemistry, 42(2), 449-456 (American Chemical Society, 1997); and in Talley, L. D. and Edwards, M., “First Low Dosage Hydrate Inhibitor is Field Proven in Deepwater,” Pipeline and Gas Journal 44, 226 (1999).

An alternative to the use of THIs and KHIs is cold flow technology, in which hydrate can be formed in a manner that prevents hydrate particles from sticking to each other without the use of chemical inhibitors. International Patent Application Publication No. WO 2007/095399 discloses a method of generating a non-plugging hydrocarbon slurry. In one aspect, the method includes seeding a cold-flow reactor before startup operation with dry hydrate particles, creating a dry hydrate sidestream by diverting a portion of wellstream of hydrocarbons into the reactor, wherein the wellstream hydrocarbons contains water, and feeding the dry hydrate sidestream into the main pipeline to be transported to a destination with the full wellstream. Since the momentum of the liquid is necessary to mobilize hydrate particles they are only effective at significant liquid loadings.

Gas dominant fields are becoming an increasing contributor to the energy production portfolio. Since gas has a much lower heat capacity than that of crude oil or water, insulation does not always offer the same benefit. Additionally, transportability limits the applicability of some thermodynamic inhibitors as well as KHIs. Also, top of the line condensation upon a cooling gas line can render a KHI ineffective since the condensed water will contain little inhibitor for preventing hydrate nucleation. Thus, research is continuing to identify techniques for preventing hydrate plugging during transport of produced gases.

### SUMMARY

An embodiment described herein provides a method for entraining hydrate particles in a gas stream, including separating a raw gas stream into a bulk water stream and a partially dehydrated gas stream, chilling the partially dehydrated gas stream to form a chilled gas stream, combining the bulk water stream with the chilled gas stream to form a transport stream including the entrained hydrate particles, and flowing the transport stream to a facility.

Another embodiment provides a system for conveying a hydrocarbon gas containing entrained hydrate particles, including a separation system configured to separate a gas stream from production water, a chiller configured to chill the gas stream, a water injector configured to inject the production water into the gas stream to form entrained hydrate particles, and a production line configured to transport the gas stream and the entrained hydrate particles to a facility.

Another embodiment provides a method for producing wet natural gas from a subsea well, comprising separating a wet natural gas stream to form bulk water and a partially dehydrated gas stream, chilling the partially dehydrated gas stream against water in the environment to form a chilled gas stream, misting the bulk water into the chilled gas stream to form a transport stream comprising entrained hydrate particles, and flowing the transport stream to a surface vessel.

### DESCRIPTION OF THE DRAWINGS

The advantages of the present techniques are better understood by referring to the following detailed description and the attached drawings, in which:

FIG. 1A is a drawing of a subsea hydrocarbon field in which hydrate particles can be created an entrained in a gas stream;

FIG. 1B is a close up view of a system that can be located at a well head to create hydrate particles in a gas stream;

FIG. 2 is a block diagram of a system that may be utilized to create entrained hydrate particles in a gas stream;

FIGS. 3A to 3C are schematic diagrams of a gas pipeline, showing different locations of a misting nozzle for injecting a water mist to create entrained hydrate particles in a gas stream;

FIG. 4 is a schematic of a jet pump that may be used for the generation of the hydrate particles in a gas stream;

FIG. 5 is a plot of the growth rate of hydrate particles versus sub-cooling prior to stream combination;

FIG. 6 is a plot of the minimum sub-cooling versus the droplet diameter;

FIG. 7 is a plot of the water to gas ratio versus the gas sub-cooling; and

FIG. 8 is a process flow diagram of a method for forming a gas stream that carries entrained hydrate particles.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, “clathrate” is a weak composite made of a host compound that forms a basic framework and a guest compound that is held in the host framework by inter-molecular interaction, such as hydrogen bonding, Van der Waals forces, and the like. Clathrates may also be called host-guest complexes, inclusion compounds, and adducts. As used herein, “clathrate hydrate” and “hydrate” are interchangeable terms used to indicate a clathrate having a basic framework made from water as the host compound. A hydrate is a crystalline solid which looks like ice and forms when water molecules form a cage-like structure around a “hydrate-forming constituent.”

A “hydrate-forming constituent” refers to a compound or molecule in petroleum fluids, including natural gas, which forms hydrate at elevated pressures and/or reduced temperatures. Illustrative hydrate-forming constituents include, but are not limited to, hydrocarbons such as methane, ethane, propane, butane, neopentane, ethylene, propylene, isobutylene, cyclopropane, cyclobutane, cyclopentane, cyclohexane, and benzene, among others. Hydrate-forming constituents can also include non-hydrocarbons, such as oxygen, nitrogen, hydrogen sulfide, carbon dioxide, sulfur dioxide, and chlorine, among others.

“Exemplary” is used exclusively herein to mean “serving as an example, instance, or illustration.” Any embodiment described herein as “exemplary” is not to be construed as preferred or advantageous over other embodiments.

A “facility” as used herein is a representation of a tangible piece of physical equipment through which hydrocarbon fluids are either produced from a reservoir or injected into a reservoir. In its broadest sense, the term facility is applied to any equipment that may be present along the flow path between a reservoir and the destination for a hydrocarbon product. Facilities may comprise production wells, injection wells, well tubulars, wellhead equipment, gathering lines, manifolds, pumps, compressors, separators, surface flow lines, and delivery outlets. In some instances, the term “surface facility” is used to distinguish those facilities other than wells. A “facility network” is the complete collection of facilities that are present in the model, which would include all wells and the surface facilities between the wellheads and the delivery outlets.

The term “FSO” refers to a Floating Storage and Offloading vessel. A floating storage device, usually for oil, is commonly used where it is not possible or efficient to lay a pipe-line to the shore. A production platform can transfer hydrocarbons to the FSO where they can be stored until a tanker arrives and connects to the FSO to offload it. A FSO may include a liquefied natural gas (LNG) production platform or any other floating facility designed to process and store a hydrocarbon prior to shipping.

The term “gas” is used interchangeably with “vapor,” and means a substance or mixture of substances in the gaseous state as distinguished from the liquid or solid state. Likewise, the term “liquid” means a substance or mixture of substances in the liquid state as distinguished from the gas or solid state. As used herein, “fluid” is a generic term that may include either a gas or vapor.

A “hydrocarbon” is an organic compound that primarily includes the elements hydrogen and carbon although nitrogen, sulfur, oxygen, metals, or any number of other elements may be present in small amounts. As used herein, hydrocarbons generally refer to organic materials that are transported by pipeline, such as any form of natural gas or oil. A “hydrocarbon stream” is a stream enriched in hydrocarbons by the removal of other materials such as water and/or THI.

“Kinetic hydrate inhibitor” refers to a molecule and/or compound or mixture of molecules and/or compounds capable of decreasing the rate of hydrate formation in a petroleum fluid that is either liquid or gas phase. A kinetic hydrate inhibitor can be a solid or liquid at room temperature and/or operating conditions. The hydrate formation rate can be reduced sufficiently by a kinetic hydrate inhibitor such that no hydrates form during the time fluids are resident in a pipeline at temperatures below the hydrate formation temperature.

“Liquefied natural gas” or “LNG” is natural gas that has been processed to remove impurities (for example, nitrogen, water, and heavy hydrocarbons) and then condensed into a liquid at almost atmospheric pressure by cooling and depressurization.

The term “natural gas” refers to a multi-component gas obtained from a crude oil well (termed associated gas) or from a subterranean gas-bearing formation (termed non-associated gas). The composition and pressure of natural gas can vary significantly. A typical natural gas stream contains methane (CH₄) as a significant component. Raw natural gas will also typically contain ethylene (C₂H₄), ethane (C₂H₆), other hydrocarbons, one or more acid gases (such as carbon dioxide, hydrogen sulfide, carbonyl sulfide, carbon disulfide, and mercaptans), and minor amounts of contaminants such as water, nitrogen, iron sulfide, wax, and crude oil. In some fields, the amount of entrained water, termed “water cut” may make the formation of hydrates problematic, especially as the hydrocarbons are depleted.

“Pressure” is the force exerted per unit area by the gas on the walls of the volume. Pressure can be shown as pounds per square inch (psi). “Atmospheric pressure” refers to the local pressure of the air. “Absolute pressure” (psia) refers to the sum of the atmospheric pressure (14.7 psia at standard conditions) plus the gage pressure (psig). “Gauge pressure” (psig) refers to the pressure measured by a gauge, which indicates only the pressure exceeding the local atmospheric pressure (i.e., a gauge pressure of 0 psig corresponds to an absolute pressure of 14.7 psia).

“Production fluid” refers to a liquid and/or gaseous stream removed from a subsurface formation, such as an organic-rich rock formation. Produced fluids may include both hydrocarbon fluids and non-hydrocarbon fluids. For example, production fluids may include, but are not limited to, oil, natural gas, and water.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

“Thermodynamic hydrate inhibitor” refers to compounds or mixtures capable of reducing the hydrate formation temperature in a petroleum fluid that is either liquid or gas phase. For example, the minimum effective operating temperature of a petroleum fluid can be reduced by at least 1.5 ° C., 3 ° C., 6 ° C., 12 ° C., or 25 ° C., due to the addition of one or more thermodynamic hydrate inhibitors. Generally the THI is added to a system in an amount sufficient to prevent the formation of any hydrate.

“Well” or “wellbore” refers to a hole in the subsurface made by drilling or insertion of a conduit into the subsurface. The terms are interchangeable when referring to an opening in the formation. A well may have a substantially circular cross section, or other cross-sectional shapes (for example, circles, ovals, squares, rectangles, triangles, slits, or other regular or irregular shapes). Wells may be cased, cased and cemented, or open-hole well, and may be any type, including, but not limited to a producing well, an experimental well, and an exploratory well, or the like. A well may be vertical, horizontal, or any angle between vertical and horizontal (a deviated well), for example a vertical well may comprise a non-vertical component.

### Overview

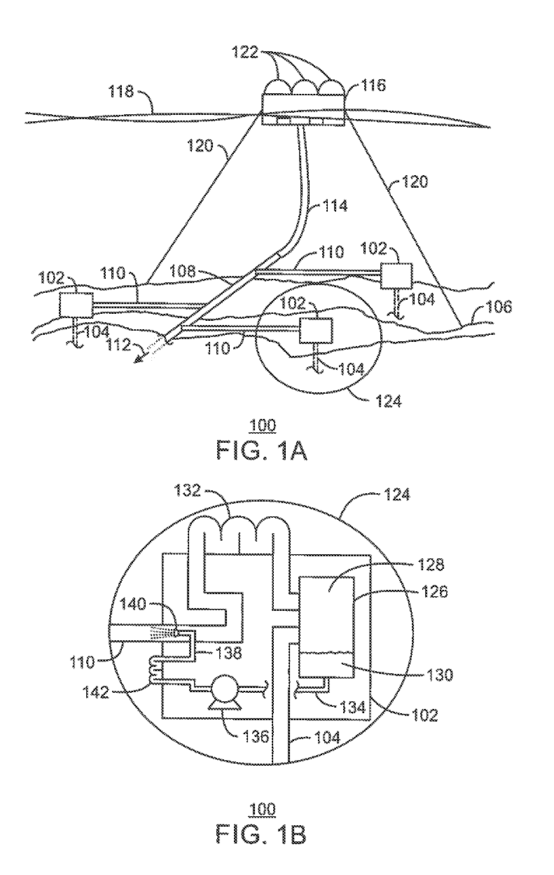

As used herein, hydrates are clathrate hydrates are formed from light gaseous components of natural gas. Hydrates are solids that can potentially form an obstruction in pipelines, such as transport lines, production lines, gathering lines, and the like. In embodiments described herein, hydrate particles are deliberately formed in a raw gas stream and conveyed in the stream as entrained solid particles. Depending on the flow rate of the gas stream, the hydrate particles may not adhere to each other or to sides of the pipeline during flow, allowing the gas to carry the entrained particles to a separation unit at a facility. The appropriate conditions for generating the hydrates in the gas stream may be created close to a wellhead, for example, in a subsea application as described with respect to FIGS. 1A and 1B. In this example, the gas stream with the entrained hydrate particles may be flowed to the surface for separation of the hydrate particles.

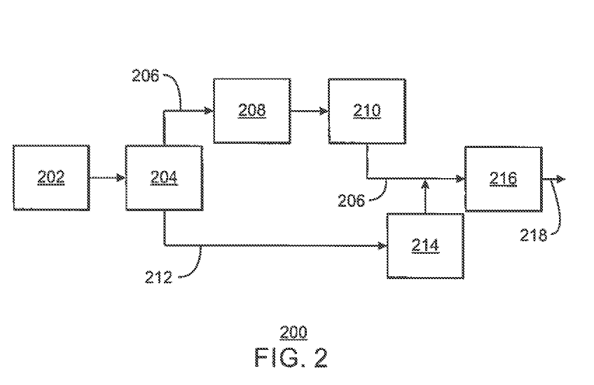

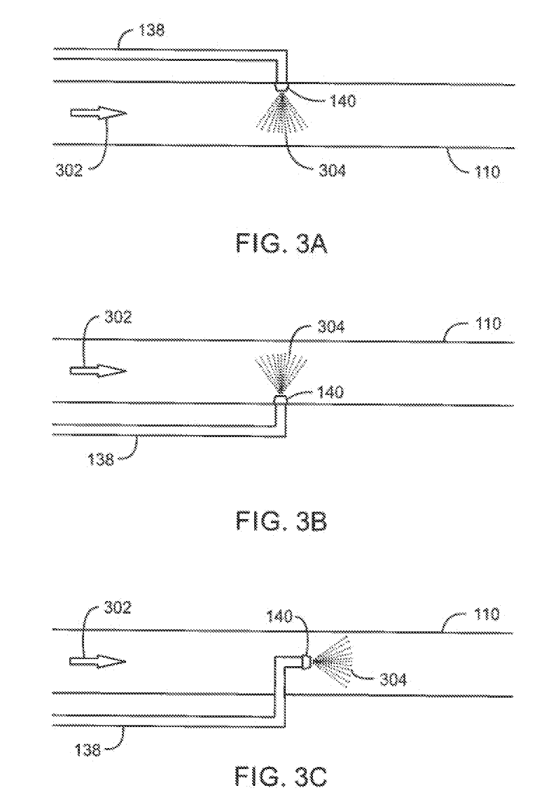

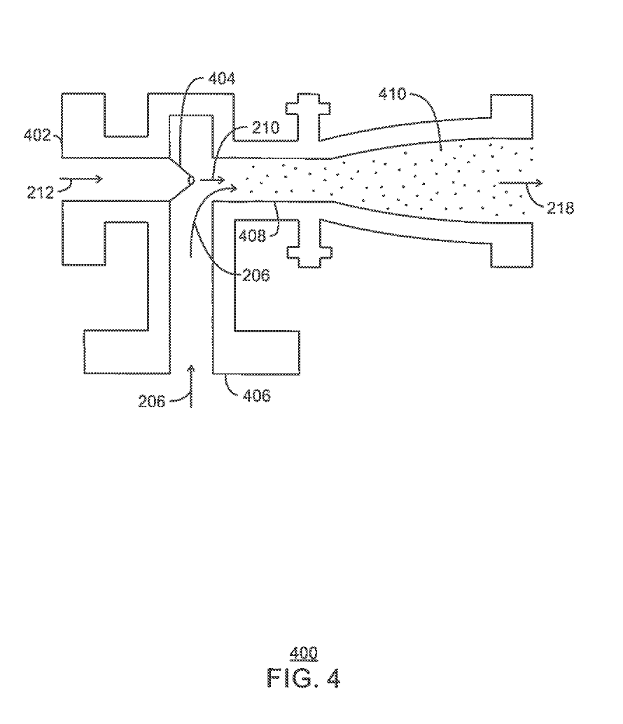

As described with respect to FIG. 2, in some embodiments, the bulk or production water can be at least partially separated from the gas stream, which may leave a residual water content. The gas stream can then be cooled to or below a hydrate formation temperature. An inhibitor may be injected into the gas stream to allow the gas stream to be sub-cooled without hydrates forming on the walls of the chiller used to cool the gas stream. The cooled gas stream may then flowed through a line that includes misting nozzles that adds the bulk water back to the gas stream, as described with respect to FIGS. 3A to 3C. Other types of equipment that form hydrate particles, such as the jet pump described with respect to FIG. 4, may also be used.

Any number of configurations described herein may be used to form the gas stream with the entrained hydrate particles. Further, the gas stream may or may not be separated or may be partially separated from the entrained water. In addition to having some residual water left in a separated gas stream, there may also be some residual gas left in the water stream before a mist generating device, such as a misting nozzle. Various configurations that may be used include sending a water stream through the misting nozzle into the separated gas stream to facilitate hydrate formation, sending an un-separated stream through the misting nozzle, sending a partially separated gas and liquid stream through the misting nozzle into a separated gas stream, and sending a slip-stream of the separated gas into the misting nozzle to assist in atomization of water to finer droplets.

The separation of the production water from the gas prior to the mist generating device may provide some benefits. For example, entrained water in a raw gas stream may be produced in slugs, leading to intermittent periods during which the hydrate generation process is starved or overwhelmed. Further, separated streams can be more effectively sub-cooled to temperatures below the hydrate stable temperature and/or treated to prevent premature hydrate formation prior to recombining the streams, which may assist the recombined hydration reaction. The formation of hydrate particles may also decrease corrosion resulting from water deposition along the piping.

The mist generating devices can include nozzles, atomizers, sonicators, static mixers, or combinations of these devices. An advantage to using a misting nozzle or atomizer is that Joule-Thomson (JT) cooling will promote nucleation and generation of hydrate from the generated mist. Formation of hydrate particles from the water and natural gas shortly after leaving a misting nozzle may prevent agglomeration and additional hydrate growth downstream.

The techniques described herein require no excess liquids for hydrate transport as the gas velocity is used to transport the entrained hydrate particles. However, further, minimal, if any, chemical additives are used to manage the hydrate formation.

FIG. 1A is a drawing of a subsea natural gas field 100 that can be protected from hydrate plugging by carrying hydrates to the surface as entrained particles within a natural gas stream. However, the present techniques are not limited to subsea fields or natural gas production, but may be used for the mitigation of plugging in the production or transportation of any number of gases that may form clathrate hydrates with water, including carbon dioxide, hydrogen sulfide, or gaseous hydrocarbon streams from any number of sources.

As shown in FIG. 1, the natural gas field 100 can have a number of wellheads 102 coupled to wells 104 that harvest natural gas from a formation (not shown). As shown in this example, the wellheads 102 may be located on the ocean floor 106. Each of the wells 104 may include single wellbores or multiple, branch wellbores. Each of the wellheads 102 can be can be coupled to a central pipeline 108 by gathering lines 110. The central pipeline 108 may continue through the field 100, coupling to further wellheads 102, as indicated by reference number 112. A flexible line 114 may couple the central pipeline 108 to a collection platform 116 at the ocean surface 118. To maintain the temperature of the gas stream with the entrained hydrate particles in a hydrate stable range, the flexible line 114, the central pipeline 108, or both may be insulated.

The collection platform 116 may be, for example, a floating processing station, such as a floating storage and offloading unit (or FSO), that is anchored to the sea floor 106 by a number of tethers 120. The collection platform 116 may have equipment for separation of the hydrate particles from the gas stream, as well as systems for dehydration, purification, and other processing, such as liquefaction equipment to form liquefied natural gas (LNG) for storage in vessels 122. The collection platform 116 may transport the processed gas to shore facilities by pipeline (not shown).

As discussed herein, prior to processing of the natural gas on the collection platform 116, the collected gas may cool and form hydrates in various locations, such as the central pipeline 108, the gathering lines 110, or the flexible line 114, among others. The formation of the hydrates may lead to partial or even complete plugging of the lines 108, 110, and 114. Similarly, in on-shore fields, hydrates can plug wells, gathering lines, and collection lines.

The techniques described herein for creating gas streams that carry entrained hydrate particles may help to mitigate this problem. Further, the separation of the entrained hydrate particles may result in a dehydrated gas stream, lowering the costs of, or need for, separate dehydration equipment. An example of a device that could be incorporated in a wellhead 102 is shown in a close up view 124 in FIG. 1B.

FIG. 1B is a close up view 124 of a system that can be located at a wellhead 102 to create entrained hydrate particles in a gas stream. The raw natural gas stream from a reservoir is flowed from a well 104 into a flash vessel 126. In the flash vessel 126, the natural gas 128 is carried upwards, allowing water 130 to settle into a pool at the bottom of the flash vessel 126. It can be noted that a flash vessel 126 may be replaced in some examples by other systems, such as a harp separation unit, for example, if needed for high pressure conditions. The natural gas 128 can be flowed through a cooler 132 to be sub-cooled below the hydrate formation temperatures. To enable sub-cooling of the natural gas 128, hydrate inhibitors may be injected prior to the cooler 132 to prevent hydrate formation in the cooler 132.

The cooler 132 in this example is a heat exchanger that uses external seawater to cool the natural gas 128, for example, in an uninsulated finned section in contact with the seawater. However, any number of other active and passive cooling systems may be used.

For example, a compressor (not shown) may be placed between the flash vessel 126 and the cooler 132 to raise the pressure of the natural gas 128. In this embodiment, the cooler 132 could remove the heat of compression. The compressed natural gas could then be chilled using a JT effect, for example, by dropping the pressure before the water 130 is reintroduced in the gathering line 110.

The water 130 may be removed from the flash vessel 126 through a bottom line 134 and sent to a pump 136 to be pressurized. From the pump 136, the water may be sent through a high pressure line 138 to a nozzle 140 that is located with the gathering line 110. A water cooler 142 may be used to sub-cool the water 130 in either the bottom line 134 or, as shown, the high pressure line 138, enhancing the formation of the hydrate particles in the gathering line 110.

FIG. 2 is a block diagram of another example of a system 200 that may form a gas stream carrying entrained hydrate particles. In this example, a wet gas stream 202 is flowed into a separation system 204, as described for the flash vessel 126 in FIG. 1B. The gas 206 from the separation system 204 may be treated with a hydrate inhibitor in another system 208. For example, the treatment may be performed by injecting an inhibitor through a misting nozzle upstream of a static mixer. The gas stream 206 can be flowed through a cooler 210, which may include a heat exchanger, or a compressor followed by a heat exchanger and JT nozzle, among others. The water stream 212 from the separation system 204 may be flowed to a mist generating device 214 that injects the water stream 212 into the gas stream 206. Another cooler 216 may be placed downstream of the mist generating device 214 to provide further cooling for the gas stream 218 with the entrained hydrate particles.

Not all of the systems shown in FIG. 2 may be used in every embodiment. For example, in applications for which the entrained water in the wet gas stream 202 is relatively constant, there may be no need to separate the water from the wet gas stream, prior to the cooler 210. Further, additional systems may be used instead of, or in addition to, the systems shown. For example, a pump may be used to boost the pressure of the water stream 212 from the separation system 204 prior to the mist generating device 214. Further, even without free water in a gas stream, JT cooling through a valve could act to form hydrate particles from water that is dissolved in the gas stream, e.g., forming a hydrate “snow” directly from the gas stream.

FIGS. 3A to 3C are schematic diagrams of a gas pipeline, such as a gathering line 110, showing different locations of a misting nozzle 140 for injecting a water mist to create entrained hydrate particles in a gas stream. Like numbered items are as described with respect to FIG. 1. The misting nozzle 140 may be placed in the flow 302 of the gas stream at various positions in the gathering line 110, such as in the top of the gathering line 110, as shown in FIG. 3A, the bottom of the gathering line 110, as shown in FIG. 3B, or at some point between, as shown in FIG. 3C. The introduction of the liquid to the intersecting gas line may be performed in a long, straight section of the gathering line 110 allowing the flow 302 to be fully developed, which may decrease the effect of eddies forcing water droplets to the walls.

Further, droplets 304 formed from the misting nozzle 140 may have sufficient residence time (t_{residence}) to react with the surrounding gas to form hydrate particles prior to contacting a wall of the gathering line 110. The residence time requirement can be reduced by minimizing the time for water droplets to form hydrate particles (t_{conversion}) for example, by sub-cooling the gas, the water, or both, or by maximizing the ratio of residence time to conversion time. The primary factors that maximize the residence time to conversion ratio are a larger flow line diameter (dₚᵢₚₑ), a smaller water droplet diameter (d_{drop}), a higher gas velocity (v_{gas}), a higher amount of sub-cooling below the hydrate formation temperature (ΔT), and a higher gas to water ratio

$$( \frac{{v}_{gas}}{{v}_{water}} ) ,$$

wherein v_{gas} and v_{watrer} are, respectively, the volume of gas and water in the flow stream. These factors can be used in the formula shown in Eqn. 1 to calculate the ratio.

$$\frac{{t}_{residence}}{{t}_{conversation}} = \frac{f ( {d}_{pipe} , {v}_{gas} , Δ T , \frac{{v}_{gas}}{{v}_{water}} )}{f ( {d}_{drop} )} \qquad ( 1 )$$

In lab tests where generation of hydrate was performed at significant water content and small amount of sub-cooling, water droplets may contact the wall of the pipe and form hydrate deposits. Thus, the velocity of the gas flow may be increased prior to the misting nozzles 140 to more effectively entrain the hydrate particles. For example, the line may be narrowed or a compressor may be added to the flow prior to cooling the partially dehydrated gas. In other instances, other types of specialized equipment, such as jet pumps, may be used to create the hydrate particles.

Downstream of the misting nozzle 140, the gas velocity may be high enough to prevent sedimentation or saltation of the hydrate particles. The required velocity will decrease with smaller hydrate particle size. Accordingly, the misting nozzle 140 may be selected to produce a very fine mist, e.g., 25-200 micrometer droplets, 50-150 micrometer droplets, and the like. Gas velocity can be optimized by modifying the production pipeline velocity or the pipeline outlet pressure at the production facility. The techniques described herein are not limited to misting nozzles 140. In some embodiments, other devices that create hydrate particles may be used, for example, as described with respect to FIG. 4.

FIG. 4 is a schematic of a jet pump 400 that may be used for the generation of the gas stream with entrained hydrate particles. Like numbered items are as described with respect to FIG. 2. In this embodiment, the water stream 212 from the separation system 204 may be injected into the jet pump 400 via a water inlet 402. In some embodiments, the water inlet 402 may include a nozzle 404 that is configured to generate a fine mist from the water stream 212 as it enters the jet pump 400.

The gas stream 206 from the separation system 204 may be injected into the jet pump 400 via a gas inlet 406. In some embodiments, the gas stream 206 may be a high velocity stream from a compressor, providing the motive force for the jet pump. The gas stream 206 may also act as the hydrate-forming constituent in the formation of the suspension of hydrate particles in the gas stream, e.g., the hydrate slurry, within the jet pump 400.

The water stream 212 and the gas stream 206 may flow through an ejection nozzle 408 within the jet pump 400. The ejection nozzle 408 may surround the water stream 212 with the gas stream 206, forming the hydrate particles 410 while keeping the droplets away from the side walls. Further, the ejection nozzle 408 may be configured to continuously increase in size, allowing the hydrate particles 410 to form without contacting the walls as the mist from the nozzle 404 diverges. Thus, towards the end of the ejection nozzle 408, the hydrate particles 410 have form, creating the gas stream 218 with the entrained hydrate particles.

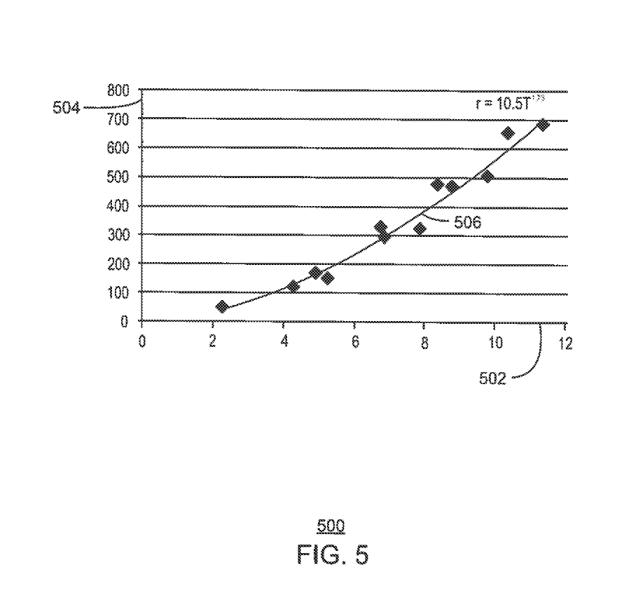

FIG. 5 is a plot 500 of the growth rate of hydrate particles versus sub-cooling prior to stream combination. The x-axis 502 represents the sub-cooling in ° C., while the y-axis 504 represents the growth rate in micrometers/s. The minimum sub-cooling 506 that a system needs to provide prior to stream combination and hydrate formation is shown as a function of achievable droplet size, flowline diameter, and proportion of water treated to sub-cooled gas. The formation rate (rate_{conversion}) for hydrates can be approximated by utilizing a film growth rate. For example, the linear film growth rates were measured as a function of sub-cooling, resulting in the minimum sub-cooling 506 shown in the plot 500. The sub-cooling fit an exponential rate expression shown in Eqn. 2.

$${rate}_{conversion} = \frac{Δ x}{{t}_{conversation}} = 10.5 Δ {T}^{1.73} \qquad ( 2 )$$

In Eqn. 2, ΔT is the sub-cooling below the hydrate formation temperature, Δₓ is the change in hydrate film surface area and, t_{conversion} is the time for formation of the hydrates from a water layer.

To approximate formation of a hydrate particle from a droplet, growth along the circumference was assumed. Since the formation on a droplet surface will occur in all directions from a nucleation point, the transform relationship follows the expression in Eqn. 3.

$$\frac{{nd}_{drop}}{2} \approx Δ x \qquad ( 3 )$$

In Eqn. 3, the terms are as defined with respect to Eqns. 1 and 2. The droplet conversion time relationship may be approximated by the expression in Eqn. 4.

$${t}_{c onversion} \approx \frac{{d}_{drop}}{6.68 Δ {T}^{1.73}} \qquad ( 4 )$$

In Eqn. 3, the terms are as defined with respect to Eqns. 1 and 2. Further, the minimum time for a droplet to contact the wall can be approximated by its terminal velocity as shown in the expression in Eqn. 5.

$${t}_{residence} = \frac{{d}_{pipe}}{4 \sqrt{\frac{{gd}_{drop} Δ ρ}{3 {C}_{D} {ρ}_{drop}}}} \qquad ( 5 )$$

In Eqn. 5, g is the gravitational acceleration (9.8 meters per second (m/s²)), C_{D} is the drag coefficient of the droplet (equal to 0.47 for a sphere), ρ_{drop} is the droplet density, and Δρ is the difference between the droplet and gas densities. All other terms are as defined with respect to Eqns. 1 and 2. Generally, though, high gas velocity will cause turbulent eddies that will keep droplets suspended for much larger periods of time.

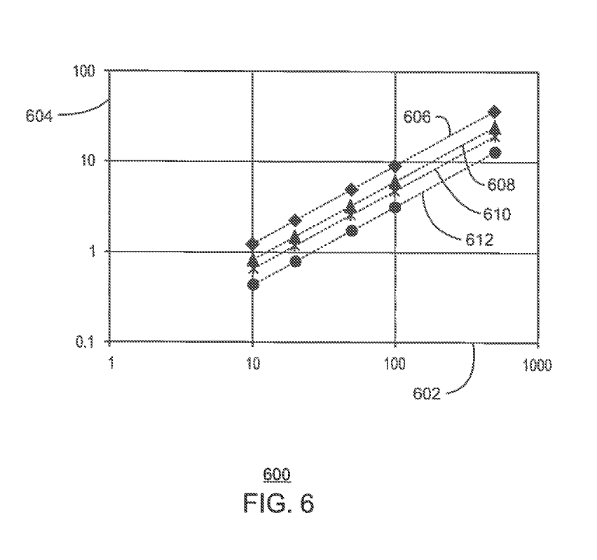

FIG. 6 is a plot 600 of the water to gas ratio versus the gas sub-cooling. In this plot 600, the x-axis 602 represents the droplet diameter in microns (log scale), and the y-axis 604 represents the minimum sub-cooling in ° C. Setting the hydrate formation time, e.g., time to form a hydrate particle from a water droplet, equal to the residence time, this plot 600 shows the minimum sub-cooling required to form a hydrate particle from a water droplet in the time before it contacts the pipewall for a four inch pipe 606, an eight inch pipe 608, a twelve inch pipe 610, and a twenty four inch pipe 612.

It should be noted that the minimum sub-cooling shown in the plot 600 is specifically directed to the sub-cooling required for total conversion prior to droplet contact with the wall. However, the energy available to convert all of the water to hydrate particles will also limit the growth of the hydrate particle. Essentially, at a specific pressure and gas composition, hydrate will form at a specific temperature, known as the hydrate formation temperature. Hydrate formation is exothermic, e.g. releasing energy as it forms. Thus, if a sub-cooled system begins to form hydrate, all of the energy associated with elevating a temperature to the formation temperature (referred to as sensible heat) is available for energy removal during the hydrate formation process. This energy of formation is referred to as the latent heat of hydrate formation, which varies by gas composition, but may be assumed to be 566 kilojoules per kilogram of hydrate (kJ/kg-hyd) for purposes of this discussion.

If the system is insufficiently sub-cooled, the temperature will rise to the hydrate formation temperature during hydrate formation, and, once the hydrate formation temperature is achieved, further growth will stop since no more sensible heat is available to provide latent heat of hydrate formation. To ensure complete conversion of all water, the total latent heat of hydrate formation associated with the water conversion may be accounted for in sub-cooling sensible heat. Since the water stream is most likely to have some gas remaining in it, sub-cooling it prematurely may lead to premature hydrate formation, and it may be preferential to sub-cool the gas to drive the hydrate formation upon recombination. Therefore, the sub-cooling required will depend on the amount of water present, as well as the amount of gas present. As the quantity of sub-cooled gas increases, the amount of sensible heat available increases. Also, as the amount of water decreases, the amount of latent heat required decreases, such that the relationship shown in Eqn. 6 exists.

$$Δ T = \frac{f ( {V}_{water} )}{f ( {V}_{gas} )} \qquad ( 6 )$$

In Eqn. 6, ΔT, v_{water}, and v_{gas}, are as defined with respect to Eqn. 1.

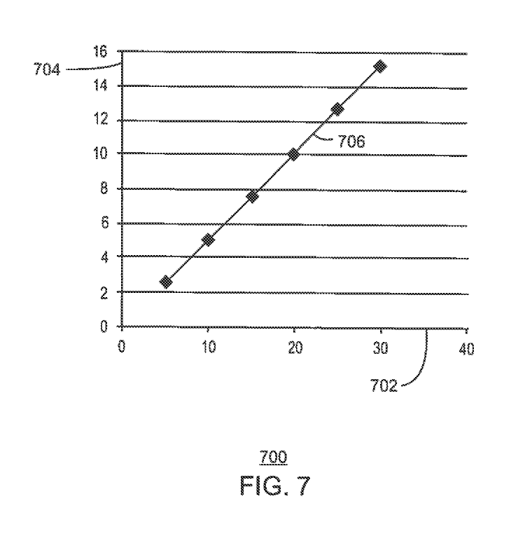

FIG. 7 is a plot 700 of the water to gas ratio versus the gas sub-cooling. The x-axis 702 represents the sub-cooling in ° C., while the y-axis 704 represents the water to gas ratio in millions of (cubic meters per 1000 standard cubic meters)(m³/ksm³x10⁶). The relationship 706 shows that the gas to water ratio is inversely proportional to the sub-cooling. Thus, the likely sub-cooling required for the amount of treated water in a gas stream may be an order of magnitude higher than that required for complete conversion before wall impact.

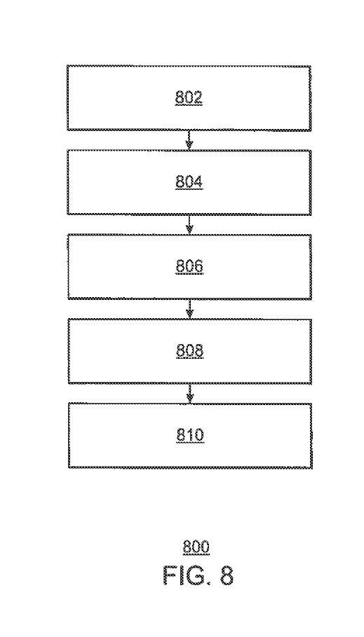

FIG. 8 is a process flow diagram of a method 800 for forming a gas stream that carries entrained hydrate particles. The method begins at block 802 with the separation of water from the gas stream. At block 804, the gas stream may be sub-cooled below a hydrate formation temperature. At block 806, the water may be pumped to a misting nozzle. The water may also be sub-cooled if the remaining gas is low enough to prevent hydrate blockages from forming At block 808, the water is reinjected into the gas stream to form hydrate particles in the gas stream, for example, through the misting nozzle. At block 810, the gas stream with the entrained hydrate particles is flowed to a facility for processing.

FIG. 8 is not intended to indicate that the steps of method 800 are to be executed in any particular order, or that all of the steps of the method 800 are to be included in every case. For example, the separation may not be performed if the amount of water entrained in the gas is not substantially changing. Further, any number of additional steps may be included within the method 800, depending on the specific application. For example, in various embodiments, liquid hydrocarbons may be separated from the gas within a subsea separation system and flowed to a facility for further processing through a separate line.

While the present techniques may be susceptible to various modifications and alternative forms, the embodiments discussed above have been shown only by way of example. However, it should again be understood that the techniques are not intended to be limited to the particular embodiments disclosed herein. Indeed, the present techniques include all alternatives, modifications, and equivalents falling within the true spirit and scope of the appended claims.

What is claimed is:

1. A method for entraining hydrate particles in a gas stream, including:
separating a raw gas stream into a bulk water stream and a partially dehydrated gas stream;
chilling the partially dehydrated gas stream to form a chilled gas stream;
combining the bulk water stream with the chilled gas stream to form a transport stream including the entrained hydrate particles; and
flowing the transport stream to a facility.

2. The method of claim 1, wherein separating the bulk water includes slowing the gas flow down to allow the water to separate.

3. The method of claim 1, wherein chilling the partially dehydrated gas stream includes exchanging heat with a surrounding environment.

4. The method of claim 1, wherein chilling the partially dehydrated gas stream includes exchanging heat with a subsea environment.

5. The method of claim 1, including treating the partially dehydrated gas stream with a hydrate inhibitor.

6. The method of claim 1, including compressing the partially dehydrated gas stream before chilling.

7. The method of claim 1, wherein chilling the partially dehydrated gas stream includes:
compressing the partially dehydrated gas stream to form a compressed gas stream;
chilling the compressed gas stream to remove the heat of compression; and
reducing the pressure of the compressed gas stream to form the chilled gas stream.

8. The method of claim 1, including increasing a flow rate of the transport stream.

9. The method of claim 1, wherein combining the bulk water with the chilled gas stream includes spraying the bulk water into the chilled gas stream through a misting nozzle.

10. The method of claim 1, wherein combining the bulk water with the chilled gas stream includes flowing the chilled gas stream through a jet pump including a misting nozzle.

11. A system for conveying a hydrocarbon gas containing entrained hydrate particles, including:
a separation system configured to separate a gas stream from production water;
a chiller configured to chill the gas stream;
a water injector configured to inject the production water into the gas stream to form entrained hydrate particles; and
a production line configured to transport the gas stream and the entrained hydrate particles to a facility.

12. The system of claim 11, including a compressor disposed upstream of the chiller configured to increase the pressure of the gas stream.

13. The system of claim 11, wherein the chiller includes a heat exchanger configured to be cooled with water from a subsea environment.

14. The system of claim 11, including a pump configured to flow water into the water injector.

15. The system of claim 11, wherein the water injector includes a misting nozzle configured to inject a mist of water from the top of the production line.

16. The system of claim 11, wherein the water injector includes a misting nozzle configured to inject a mist of water from the bottom of the production line.

17. The system of claim 11, wherein the water injector includes a misting nozzle configured to inject a mist of water down a center line of the production line.

18. The system of claim 11, including a hydrate generator configured to create the entrained hydrate particles by injecting the water mist into a gas stream in a jet pump.

19. A method for producing wet natural gas from a subsea well, comprising:
separating a wet natural gas stream to form bulk water and a partially dehydrated gas stream;
chilling the partially dehydrated gas stream against water in the environment to form a chilled gas stream;
misting the bulk water into the chilled gas stream to form a transport stream comprising entrained hydrate particles; and
flowing the transport stream to a surface vessel.

20. The method of claim 19, including creating the transport stream at a subsea wellhead.

21. The method of claim 19, including insulating a production line to keep a temperature of the transport stream below a hydrate formation temperature.

22. The method of claim 19, including separating the hydrate particles from the transport stream on a surface vessel.
